(19) United States
(12) Patent Application Publication
(10) Pub. No.: US 2009/0065970 A1
(43) Pub. Date: Mar. 12, 2009

(54) Novel fibers, high airtightness fabrics and a fabrication method thereof

(75) Inventors: Lien Tai Chen, Taoyuan (TW); Kai Jen Hsiao, Miaoli (TW); Shu Hui Cheng, Hsinchu (TW); Zhi Feng Jue, Yunlin (TW)

Correspondence Address: BACON & THOMAS, PLLC, 625 SLATERS LANE, FOURTH FLOOR, ALEXANDRIA, VA, 22314-1176, US

(73) Assignee: Industrial Technology Research Institute, Hsinchu (TW)

(21) Appl. No.: 12/230,270

(22) Filed: Aug. 27, 2008

Related U.S. Application Data
(62) Division of application No. 11/487,464, filed on Jul. 17, 2006.

(30) Foreign Application Priority Data
Sep. 30, 2005 (TW) 94134164

(51) Int. Cl. D01D 5/253; B29C 47/08

(52) U.S. Cl. 264/177.13

(57) ABSTRACT

The present invention provides a new tetragon fiber and a method for fabricating the same. The present invention includes: heating a thermoplastic material, extruding it from a tetragon-shaped nozzle, passing it through an airless zone, then cooling and solidifying to form threadlike substances, rolling up then processing the threadlike substances to form fibers with tetragon cross sections. The fabrics of present invention comprises a property of fine air-tightness.

### CROSS REFERENCES TO THE RELATED APPLICATIONS

This application is a divisional application of pending of U.S. patent application Ser. No. 11/487,464, filed Jul. 17, 2006 (of which the entire disclosure of the pending, prior application is hereby incorporated by reference).

### BACKGROUND OF THE INVENTION

1. Field of the Invention

The present invention relates to a novel fiber, high airtightness fabrics and a fabricating method, more particularly a fabricating method for a tetragon fiber and fabrics made of the tetragon fiber. The present invention provides high airtightness fabrics by compact arrangement of the tetragon fibers.

2. Description of the Related Art

High airtightness fabrics have been used extensively in clothing-related products such as waterproof, windproof, and warmth-retention fabrics. Industrial applications of high airtightness fabrics include the leisure articles, packing materials, shoes materials, conveying belts, automobile airbags and other textile products. In general, the fibers used in air-tight fabrics must be able to yield high degrees of compaction and thus low interstices among the fibers to lower the air permeability.

Conventional man-made fibers typically have round cross sections. These round fibers stack up with a high degree of interstices among the fibers, which leads to high air permeability. In order to fabricate a high airtightness fabric, the inter-fiber spaces must be reduced or minimized. The prior art uses resin coating to seal or weaving with high shrinkage fibers to reduce the inter-fiber spaces. Nevertheless, resin coating may cause environmental problems and, in addition, induce higher production costs. On the other hand, fabrics with high shrinkage fibers may encounter a difficulty of controlling the final fabric density or basis weight after shrinking processing. Moreover, high shrinkage fibers in general do not have sufficient tensile strength for industrial applications.

One of the industrial applications which imposes stringent requirements on airtightness of the fabric is the automobile airbag. The airbag fabric must have low air permeability, in addition to dimensional stability and durability, to ensure high performance on instant inflation of the airbag in action. Commercial products generally have air permeability less than 1.0 cc/cm²·sec. The desired air permeability is as low as possible.

In order to achieve the lowest air permeability possible, the fibers should be designed to provide lowest degree of inter-fiber spaces. Tetragon fibers, preferably square fibers, are most desirable for this purpose. The prior arts JP2002-129444 and JP2003-183945, both are Japanese patents, disclose a flat fiber and airtight fabrics made of this fiber. However, the flat fibers have relatively low tensile strength. Furthermore, it is necessary but difficult to control the fiber orientation during the weaving process.

In order to improve the prior art of high airtight fabrics, it is worth to develop a fabrication method of high airtight fabrics with low-cost and mild pollution.

### SUMMARY OF THE INVENTION

As the descriptions above, the prior technology of fabricating airtight fabrics usually adopts resin coating and have environmental pollution problems. The present invention provides a method for fabricating tetragon fibers. The main purpose of the invention is to achieve ultrahigh airtightness in fabrics by altering the cross section of the fiber to tetragonal shape and compacting the stacking of the tetragon fibers in fabrics. A fiber of tetragonal cross section may be partially oriented yarn (POY), fully oriented yarn (FOY) or spin draw yarn (SDY).

By the nature of the tetragon cross section, the fibers can be arranged with minimal interstices in the fabricated fabrics to achieve the objective of high airtightness. Furthermore, the production is straightforward, using no polluting coating and therefore potentially low-cost as compared to the prior arts.

Another objective of the present invention is to provide a fabric made of the tetragonal fiber that may be used in the production of airbag, safety belt, tent, and other industrial products requiring high airtightness or fabric density.

To achieve the objectives aforesaid, the present invention provides a method for fabricating tetragon fibers, comprising the steps of melting a thermoplastic polymer; extruding the molten polymer from a special contoured nozzle which yields the tetragonal cross section in the molten polymer threads; passing the molten polymer threads through a modified quenching zone, in which the cooling air blocking section is reduced at the upper part of the quenching zone; solidifying the molten polymer threads to form solid polymer threads; and finally, rolling up and stretching the polymer threads to form fibers with a tetragonal cross section. Preferably the length of the shortened air-blocked zone is within 0.1-15 cm; the ratio of the long to the short side of the tetragonal cross-section is in the range of 1.0-2.0.

The tetragon fiber provided by the present invention is produced by the method aforementioned. The cross section of the tetragon fiber is preferably a rectangle, and most preferably a square. The tetragon fiber of the present invention may be a non-hollow tetragon fiber or a hollow tetragon fiber, preferably the non-hollow tetragon fiber.

The fiber material is a thermoplastic polymer, copolymer or mixture thereof. The thermoplastic polymer includes, but is not limited to polyamide resin, polyester or polyolefin; the preferred polyamide resin is the nylon family, e.g. Nylon 6, Nylon 11, Nylon 12, Nylon 46, Nylon 66, Nylon 610, and Nylon 612, etc. Other examples of polyamide resin suitable for the present invention are described in pp. 19-20 of J. Gordon Cook's Handbook of Textile Fibres, 5th edition, Trowbridge GB (1984). The relative viscosity of the polyamide resin used for fabricating the fiber of the present invention is preferably in the range of 30-150 (tested with 90% HCOOH at a concentration of 1.0 g/dl and 25° C.). The polyester used by the present invention includes but is not limited to polyethylene terephthalate (PET), polytrimethylene terephthalate (PTT) or polybutylene terephthalate (PBT). The polyolefin used by the present invention includes but not limited to polyethyelene (PE) and polypropylene (PP).

The present invention further provides a fabric made of the aforementioned tetragon fiber, in which the warp and the weft fibers may be consisted of monofilament or multifilament fibers.

The present invention presents a novel method of producing a tetragonal non-hollow fiber by the design of a special contour-shaped nozzle hole and the design of a shortened air-blocked zone in the spinning duct. The shape of the fiber thereof differs from the round or elliptical shape of traditional fibers. The fiber with a tetragon cross section of the present invention yields a denser fabric construct than traditional fibers with round cross sections in the weaving process; hence the airtightness and thus the windproof performance of the fabrics increase. In summary, the tetragon fiber, fabrics thereof and the manufacturing method of the present invention present a new technology of making airtight fabrics to reach a performance level which has not been achieved before by noncoated fabrics. These high performance airtight fabrics are suitable for many apparel and industrial applications.

### BRIEF DESCRIPTION OF THE DRAWINGS

FIG. 1 illustrates the modified quenching zone with a shortened air-blocked section of the spinning apparatus of the present invention as compared to the prior art.

FIG. 2 exhibits the cross section of fibers fabricated according to Example 1 of the present invention.

FIG. 3 shows the comparison of the cross section views of Example 1 in the present invention (a) and the traditional round fiber (b).

FIG. 4 shows the stacking-up cross section of Example 1 in the present invention (a), and the cross section of traditional round fibers (b).

### DETAILED DESCRIPTION OF THE INVENTION

The present invention is described as follows. The diagrams accompanying the descriptions below are not presented in actual proportion; they are used only for illustration of the equipment setup of the present invention.

The present invention relates to a special tetragon fiber and a high airtightness fabric made by the fiber. The airtight fabric may be used in applications requiring low air permeability such as automobile airbags and others. The fiber of the present invention is produced by melting a thermoplastic polymer to form a molten polymer, which is extruded from special contoured nozzles and passed through a shortened air-blocked section in the air quenching zone for accelerated solidification of the filaments. The spinning conditions are controlled to maintain the tetragonal shape in the spinning line.

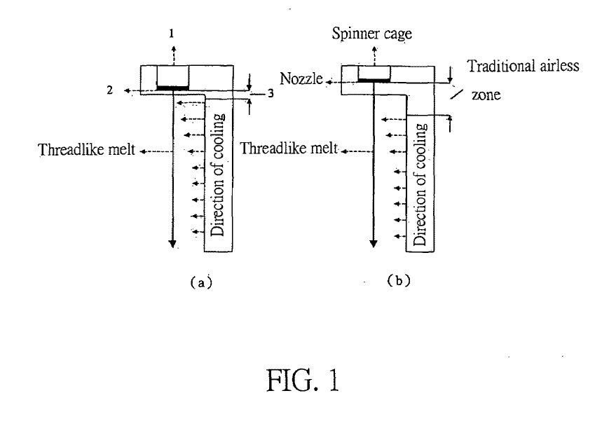

The spinning apparatus, which only shows the portion corresponding to the description in the specification, is shown in FIG. 1. More specifically, FIG. 1(a) illustrates the design of the shortened air-blocked section in the air quenching zone in the present invention; FIG. 1(b) displays the corresponding design of the air quenching zone in a traditional setup. Referring to FIG. 1(a), the method of fabricating the tetragon fiber of the present invention comprises the steps of: heating and melting a thermoplastic polymer; extruding the molten polymer from the special contour-shape nozzle; passing it through an air-blocked zone in the form of molten filaments; cooling and solidifying the molten filaments in the air quenching zone to form solid filaments; finally, drawing the filaments to form fibers of the desired tetragon cross section and winding up on a winder.

The cross section of the tetragon fiber preferably has a rectangular shape, and more preferably a square shape. The shape of the nozzle hole is determined by the shape of the target fiber. More precisely, the tetragon fiber is made with a nozzle of contoured tetragon holes; similarly, the square fiber is extruded through a nozzle of contoured square holes. The molten polymer, after leaving the nozzle, swells to the desired tetragonal or square shape with proper control of spinning conditions.

Another important feature of the present invention which renders easier control of the fiber cross section is the shortened air-blocked section in the air quenching zone to accelerate cooling which leads to the fixation of the desired cross section in the molten filaments. In this apparatus, the molten polymer, after being extruded from the nozzle, enters the air quenching zone more quickly than in conventional spinning apparatus as a result of the reduced length of the air-blocked zone. Preferably the length of the air-blocked zone is set at 0.1-15 cm, and more preferably 0.1-5 cm. The length of the traditional air-blocked zone is approximately 20-30 cm, as shown in FIG. 1(b).

The method for preparing the airtightness fiber of the invention comprises the following steps. First, heat and melt the fiber material. The nozzle temperature, which varies with the fiber material, is generally set in the range of 180-320° C., above the melting point of the fiber material. For example, the nozzle temperature for preparing the polyamide 66 fiber is set at 285-300° C. Second, the melted fiber material extruded from the nozzle is cooled and solidified quickly to form solid filaments in the air quenching zone. Cooling and solidifying is conducted by blowing cold air of 15-23° C. and application of finish oil to consolidate the filament bundle. The cooling air speed is 0.1-1.5 m/sec, and more preferably 0.5-1.0 m/sec. The solidified filaments are subsequently winded up or further drawn in a heated roller set to achieve desired fiber properties before being winded up.

The spun fiber may be subjected to texturing processes such as false twisting, air texturing or others to enhance the bulkiness of the fiber and fabrics. It should be noted that the cross section of the fiber must be maintained throughout the process of drawing or texturing. The tetragon fiber produced by the aforementioned process may have the ratio of the long side vs. the short side of tetragon cross-section is preferably between 1.0 and 2.0.

The fibers produced by the aforementioned process are used to construct fabrics by weaving. The fabrics comprise weft and warp yarns of 10-500 threads/inch. In general the tetragon fibers herein can be used to produce all kinds of fabrics, but not limited to woven, knitted, and non-woven structures. The fabrication methods for the fabrics are known to all skilled textile professionals and are not otherwise specified or described.

By the nature of tetragon cross section, fibers can be arranged and stacked in a very compact format, which leads to high airtightness in the fabrics. The fabrics can be applied in windproof and thermal wears, shoe material, tent, conveying belt, and air bag, etc.

The present invention is further illustrated in the following Examples; however, the Examples should not be construed as a limitation of the present invention. Professionals familiar with the skill in the art are able to make various modifications and alterations without departing from the spirit and the scope of the present invention.

### EXAMPLES

### Example 1

### Fabrication of Square Fibers Used for the Production of High Airtightness Fabrics

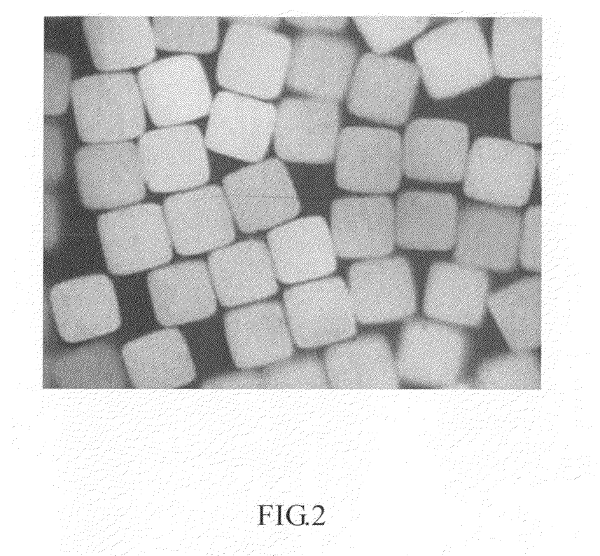

With the method of the present invention, Nylon 66 chips of RV 100 is charged into an extruder, heated and melted at 290° C. and extruded, at a rate of 72 g/min, from a special contoured nozzle to form molten polymer threads of tetragonal cross section. The molten filaments are passed through an air-cooling zone, in which air is blocked for a length of 5 cm at the upper part of the zone; a quenching air of 0.7 m/sec is blown at the rest of the cooling zone. The molten filaments are solidified and sprayed with finish oil to achieve a dynamic coefficient of friction of 0.35 (F/Uμd) at the location of 150 cm below the exit of the spinning nozzle. The solidified tetragon filaments are fed into a heated roller set and drawn at a ratio of 5.0. The winding tension of the filaments is controlled around 0.15 g/d, and the winding speed is set at 3200 m/min. The fiber obtained has a tenacity of 8.3 g/denier and a breaking elongation of 19%. The cross section of the fiber is as shown in FIG. 2.

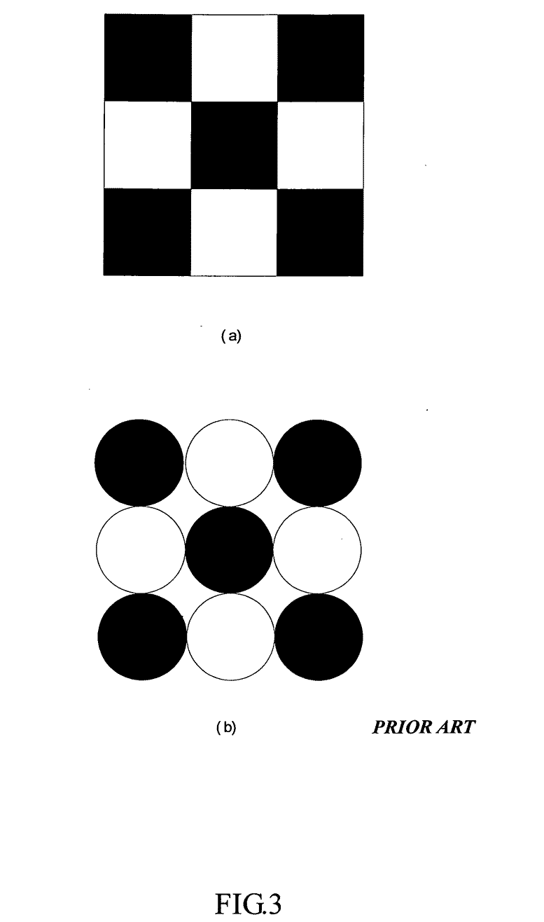

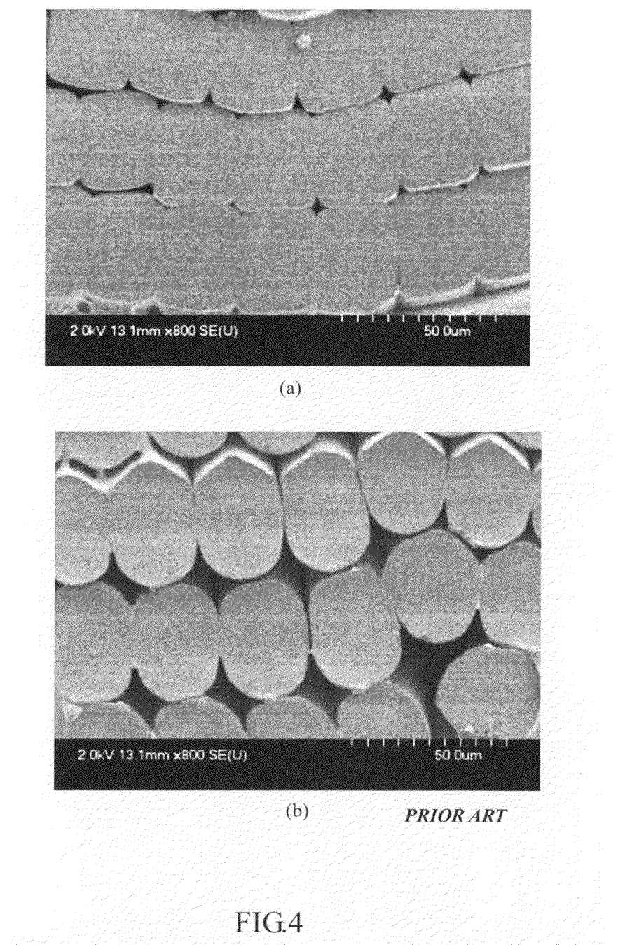

FIG. 3(a) is a sketch of the perfectly stacked squares, while FIG. 3(b) is a sketch of the perfectly stacked spheres. The higher packing density of the squares is the logic behind the present invention. FIGS. 4(a) and (b) show the scanning electron micrographs of the physical fibers of square and round cross section. By comparing FIG. 3 and FIG. 4, it is found that the fabric produced by the fibers of the present invention comprise less gap among square cross sections, which leads to higher fabric density and lower permeability. The fabric produced by the cross sections of traditional round fibers, on the contrary, contains more interstitial spaces.

### Example 2

### Preparation of High Airtightness Fabric with the Fibers of Present Invention

The square fiber obtained in Example 1 is used to produce woven fabrics to investigate its effect on air permeability. Two weaving densities have been adopted in the construction of the fabrics: 49 and 55 threads/inch for both the warp and the weft directions. The first part of the experiments uses the square fiber to investigate the effect of the square fiber on air permeability as the weft yarn only. The second part of the experiments employs the square fiber in both the weft and the warp directions to fully exploit the effect of the square fiber on airtightness. In construction of the first part, Du Pont's T725 420d /68f M1V297 industrial yarn, which is of round cross section, is used for the warp; the square fiber obtained in Example 1 and Du Pont's round fiber, same as the warp, are used for the weft. The content of the fibers in the fabrics is therefore roughly 50% round fiber and 50% square fiber. The air permeability data are shown in Table 1. For the 65*49*49 construction, the fabric with the square fiber as the weft yarn has a permeability of 0.335 cc/cm²·sec, which is 57% lower than the 0.782 cc/cm²·sec of the control sample with all round fibers. For the denser 65*55*55 construction, the fabric with the square fiber as the weft yarn has a permeability of 0.117 cc/cm²·sec, which is 45% lower than the 0.213 cc/cm²·sec of the controlled sample with 100% round fibers.

In the second part of the experiments, both the warp and the weft yarns employ the square fiber. The air permeability is further decreased to 0.168 and 0.057 cc/cm²·sec for the 65*49*49 and 65*55*55 constructions, respectively. The data are shown in Table 1.

In the production of the above fabrics, the weaving tension is controlled to be 95 and 100 kg for the 65*49*49 and 65*55*55 constructions, respectively. The woven fabrics are subsequently heat-set at 185° C. at a conveyor speed of 30 m/min.

TABLE 1
Comparison of the air permeability of the fabrics constructed with the
square and the round fiber

| Woven fabric | | | | |
|---|---|---|---|---|
| Width (inch)* | | | | |
| warp density | | | | |
| (threads/inch)* | | | Air | Differ- |
| weft density | Warp | Weft | permeability | ence |
| (threads/inch) | (420d/68f) | (420d/68f) | (cc/cm²⁻ sec) | (%) |
| 65*49*49 | Dupont | Dupont | 0.782 | — |
| | (round fiber) | (round fiber) | | |
| | Dupont | ITRI | 0.335 | 57.2 |
| | (round fiber) | (square fiber) | | |
| | ITRI | ITRI | 0.168 | 78.5 |
| | (square fiber) | (square fiber) | | |
| 65*55*55 | Dupont | Dupont | 0.213 | — |
| | (round fiber) | (round fiber) | | |
| | Dupont | ITRI | 0.117 | 45.1 |
| | (round fiber) | (square fiber) | | |
| | ITRI | ITRI | 0.057 | 73.2 |
| | (square fiber) | (square fiber) | | |

In summary, the fibers disclosed in the present invention have a tetragonal cross section and the woven fabrics made thereof exhibit higher air permeability than the fabrics with conventional round fibers. As a comparison, the fiber in the prior art JP2002129444 may also be used to produce airtight fabrics; however, the strength uniformity of the fabrics is not adequate due to the difficulty of the tension control in the weaving process. In the prior art JP2003183945, airtight fabrics are fabricated by coating the fabrics with resin. Coating uses chemicals which generally cause environmental pollution; furthermore, resin coating may peel off in use and involve higher production cost. On the contrary, the tetragon fiber, and in particular the square fiber, of the present invention employs the physical principle of compact stacking of the special cross section.

### OTHER EMBODIMENTS

The preferred embodiments of the present invention have been disclosed in the Examples. However the Examples should not be construed as a limitation on the actual applicable scope of the invention, and as such, all modifications and alterations without departing from the spirits of the invention and appended Claims shall remain within the protected scope and Claims of the invention.

1. A method of fabricating a fiber of tetragonal cross section, which is partially oriented yarn (POY), fully oriented yarn (FOY) or spin draw yarn (SDY), comprising the steps of:
melting a fiber material, which is a kind of thermoplastic polymer;
extruding said molten polymer from a special contoured nozzle and then passing said molten polymer through an air-blocked zone to form molten filaments;
solidifying said molten filaments to form solid filaments; and
drawing said solid filaments to form fibers with tetragonal cross sections; the distance of the air-blocked zone ranges from 0.1 to 15 cm; and
the ratio of length vs. width of said tetragonal cross section is 1.0-2.0.

2. The method of claim 1, wherein said distance of air-blocked zone is in the range of 0.1 to 15 cm.

3. The method of claim 1, wherein said fiber material is melted by heating at a temperature of 180-320° C.

4. The method of claim 1, wherein said molten filament is cooled and solidified by quenching air.

5. The method of claim 4, wherein said quenching air is blown at a speed of 0.1-1.5 m/sec.

6. The method of claim 1, wherein said drawing method is performed by feeding solidified filaments into a heated roller set with rollers operating at differential speeds to effect drawing.

7. The method of claim 6, wherein said roller set provides a draw ratio of 1-8.

8. The method of claim 1, wherein the drawing tension is 0.01-1.0 g/d.

9. The method of claim 1, wherein the winding speed is 2000-8000 m/min.
